(19) United States
(12) Patent Application Publication
(10) Pub. No.: US 2007/0225839 A1
(43) Pub. Date: Sep. 27, 2007

(54) Apparatus and method for processing audio data

(75) Inventor: Hirofumi Nagaoka, Kawasaki (JP)

Correspondence Address: ARENT FOX PLLC, 1050 CONNECTICUT AVENUE, N.W., SUITE 400, WASHINGTON, DC, 20036, US

(73) Assignee: FUJITSU LIMITED

(21) Appl. No.: 11/484,742

(22) Filed: Jul. 12, 2006

(30) Foreign Application Priority Data
Mar. 23, 2006 (JP) 2006-081630

(51) Int. Cl. G06F 17/00

(52) U.S. Cl. 700/94

(57) ABSTRACT

An ExOR circuit performs volume comparison between a sound level expressed by audio data and zero level by detecting whether or not the sign of audio data at a given time stored in a first register is inverted from a sign of audio data which is one sample before the audio data at the given time stored in a second register. A shift register for shifting audio data outputted from the first register changes the sound level by changing the shift amount every time the ExOR circuit detects the sign inversion.

### CROSS REFERENCE TO RELATED APPLICATION

This application is based upon and claims the benefit of priority from the prior Japanese Patent Application No. 2006-81630, filed Mar. 23, 2006, the entire contents of which are incorporated by reference.

### BACKGROUND OF THE INVENTION

1. Field of the Invention

The present invention relates to a technology for processing audio signals, particularly to a technology for limiting abnormal sound generated when the signal level of an audio signal is rapidly changed.

2. Description of the Related Art

In recent years, the audio signal processing system chip market has been increasingly expanded in the leading product markets of DVD players, digital camcorders, and portable audio players among many other products. In the digital audio output systems typically incorporated into such equipment, mute processing is often performed in order to prevent abnormal sounds such as noise sounds from being outputted when processing (such as decode processing) is stopped, when channels are switched, or when normally processed sound is not be able to be generated due to occurrence of an error, among other situations.

In mute processing, first, the output of an audio signal is stopped in order to shift to a mute state. After that, each desired type of processing is performed. After finishing each type of processing, the mute state is released to restart output of the audio signal. For example, in Japanese Patent Application Publication No. H10-126386, a technology in which audio output is muted when the number of detecting errors exceeds a given threshold in a receiver of digital audio broadcasting, has been disclosed.

However, in the mute processing mentioned above, when the signal level of an audio signal (hereinafter referred to as sound level) is rapidly changed down to zero level (0, or silent level), noise sound is generated. Additionally, when the mute processing is finished, in order to return to the preceding sound level, if the sound level is rapidly changed from the zero level, similar noise sound is generated as well.

To remove such noise sound generated by a rapid change of the sound level, soft mute processing for gradually increasing and decreasing a sound level has been proposed.

For example, in Japanese Patent Publication No.3125516 discloses a technology which: detects when a change of audio broadcasting modes occurs, performs a fade-out by soft mute, switches the data processing mode to the processing mode corresponding to the changed audio broadcasting mode, and then releases (fades-in) the soft mute.

Further, Japanese Patent Publication No. 2841973 discloses a technology of a soft mute circuit which is composed of a plurality of AND circuits for performing AND operation between serial data sequentially inputted from the least significant bit of an audio signal and parallel data which is an attenuation coefficient, an addition circuit for performing accumulative addition while shifting the output therefrom in the lower direction, and a register that does not use a large-scale multiplication circuit.

It is often the case that a soft mute circuit for effectuating such mute processing is realized by using a multiplication circuit and sequentially multiplying audio data by a coefficient that is incrementally decreased or increased. However, when a multiplication circuit is used, the circuit scale becomes large. From this viewpoint, in the above Japanese Patent Publication No. 2841973, discloses a soft mute circuit which does not use a multiplication circuit. However, even when the circuit scale is reduced by such a disclosed technology, the reduction level may not be sufficient in some cases.

### SUMMARY OF THE INVENTION

An object of the invention is to provide a new soft mute technique in which the generated amount of noise sound is reduced.

An audio data processing apparatus, according to an aspect of the invention, includes a comparing unit for performing volume comparison between a sound level expressed by audio data and a given threshold and a changing unit for changing the sound level expressed by the audio data when a result of the comparison by the comparing unit is changed.

According to the foregoing structure, when a sound level is sufficiently small, the sound level can be changed. Therefore, a generated amount of noise sound can be reduced.

In the above audio data processing apparatus, according to this aspect of the invention, the given threshold can be set to zero level.

Here, the audio data can be expressed in the form of two's complement, the comparing unit can have a detecting unit for detecting a sign change point of the audio data, and the changing unit can change the sound level expressed by the audio data at the sign change point.

According to the foregoing structure, when a sound level is zero level, the sound level can be changed.

Here, the detecting unit may detect whether or not the sign of data at a given time of the audio data is inverted from the sign of data that is one sample before the data at the given time of the audio data.

According to the foregoing structure, the detection unit can detect a sign change point of audio data.

Here, the above audio data processing apparatus can additionally include a first register for storing the audio data and a second register for storing audio data which is one sample before the audio data stored in the first register. Further, the detecting unit can be an exclusive OR circuit which outputs exclusive OR between the sign bit of the audio data stored in the first register and the sign bit of the audio data stored in the second register.

According to the foregoing structure, the detecting unit can detect whether or not the sign of data at a given time of audio data is inverted from the sign of data which is one sample before the data at the given time of the audio data.

Further, in the above audio data processing apparatus according to an aspect of the invention, the changing unit can also be a shift register for shifting the audio data.

According to the foregoing structure, the changing unit can be structured as a small-sized circuit.

Here, the audio data can be expressed in the form of two's complement, the comparing unit can have a detecting unit for detecting the sign change point of the audio data, and the shift register can alter the shift amount of the audio data every time the detecting unit detects the sign change point.

According to the foregoing structure, when a sound level is zero level, the shift register can change the sound level.

Otherwise, the audio data here may be expressed in the form of two's complement, the comparing unit can have a detecting unit for detecting the sign change point of the audio data, and the shift register can change the shift amount of the audio data every time the detecting unit detects the sign change point a specified number of times.

According to the foregoing structure, the ratio of change of the sound level by mute processing can be moderate.

Further, in the above audio data processing apparatus according to the aspect of the invention, the audio data can be expressed in the form of two's complement and the comparing unit can produce a result of the comparison based on whether or not all values of high bits in a given number of digits in the audio data correspond with the value of the sign bit of the audio data.

According to the foregoing structure, the result of the volume comparison between the sound level expressed by audio data and a given threshold can be obtained.

Further, the above audio data processing apparatus, according to this aspect of the invention, can further include a threshold changing unit for changing the give threshold when the result of the comparison by the comparing unit is changed.

According to the foregoing structure, time needed for mute processing can be shortened.

Furthermore, the invention also relates to an audio data processing method used in the above audio data processing apparatus according to this aspect of the invention.

According to the aspect of the invention, by structuring the audio data processing apparatus as above, the effects of realizing soft mute with a reduction in the generated amount of noise sound can be obtained.

### BRIEF DESCRIPTION OF THE DRAWINGS

The invention will be more apparent from the following detailed description when the accompanying drawings are referenced.

FIG. 1 is a diagram showing a structure of an audio data processing apparatus embodying the invention;

FIG. 2A is a flowchart (No. 1) for explaining operations of the audio data processing apparatus;

FIG. 2B is a flowchart (No. 2) for explaining operations of the audio data processing apparatus;

FIG. 3A is a diagram showing change in a sound level by mute processing of fade-out when timings of changing shift amounts in a shift register are not considered;

FIG. 3B is a diagram for explaining timings of changing shift amounts in the shift register;

FIG. 3C is a diagram showing change in a sound level by mute processing of fade-out when timings of changing shift amounts in the shift register are considered;

FIG. 4A is a diagram for explaining a first modified example of the structure of the audio data processing apparatus of FIG. 1;

FIG. 4B is a diagram for explaining a second modified example of the structure of the audio data processing apparatus of FIG. 1;

FIG. 5A is a diagram for explaining a third modified example of the structure of the audio data processing apparatus of FIG. 1;

FIG. 5B is a diagram for explaining a fourth modified example of the structure of the audio data processing apparatus of FIG. 1;

FIG. 6 is a flowchart (No. 3) for explaining operations of the audio data processing apparatus; and

FIG. 7 is a diagram for explaining a fifth modified example of the structure of the audio data processing apparatus of FIG. 1.

### DESCRIPTION OF THE PREFERRED EMBODIMENT

Hereinafter, an embodiment of the invention will be described with reference to the drawings.

In the embodiment hereinafter described PCM (Pulse Code Modulation) audio data expressed in the form of two's complement is used.

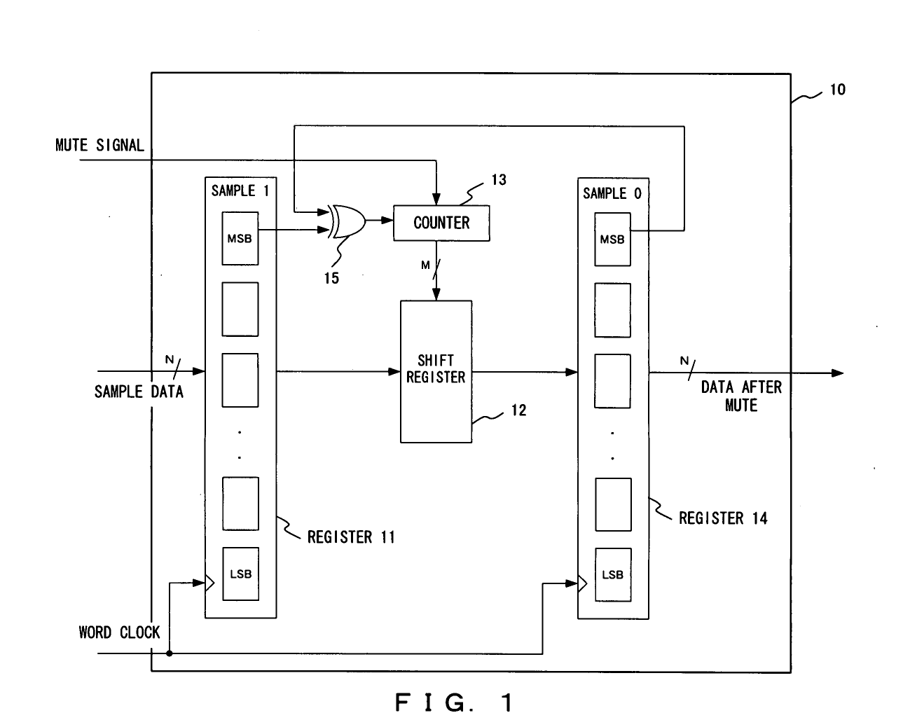

The first description will be that of FIG. 1. FIG. 1 shows a structure of an audio data processing apparatus for embodying the invention.

Audio data (sample data) inputted to an audio data processing apparatus 10 shown in FIG. 1 is initially stored in a register 11. The stored audio data is read for every one word based on a word clock and sent to a shift register 12.

The shift register 12 shifts the inputted audio data for every word in the low bit direction by the number of bits corresponding to a count value of a counter 13 and outputs the audio data to a register 14. That is, the shift register 12 is both a circuit for performing two's power multiplication for audio data and changing a sound level expressed by audio data.

The register 14 stores the audio data outputted from the shift register 12. The stored audio data is read for every one word based on the word clock and is outputted from the audio data processing apparatus 10. Here, the shift register 12 and the shift register 14 are connected in series and the readout from the both registers is based on the same word clock. Therefore, audio data that is one sample before the audio data stored in the register 12 is stored in the shift register 14.

An exclusive OR circuit (hereinafter abbreviated to “ExOR”) 15 outputs exclusive OR between the most significant bit (MSB) of the audio data stored in the register 11 and the most significant bit of the audio data stored in the register 14.

In this embodiment, audio data is expressed in the form of two's complement and the most significant bit of audio data represents a sign. Therefore, The ExOR 15 detects whether or not the sign of the audio data stored in the register 11 is inverted from the sign of the audio data stored in the register 14. When the sign is inverted, the ExOR 15 outputs “H” level; when the signs correspond with each other, the ExOR 15 outputs “L” level. That is, the ExOR 15 is a circuit for detecting the sign change point of audio data. It is possible to say that the ExOR 15 is a circuit for performing volume comparison between the sound level expressed by audio data and zero level and detecting that a result of the volume comparison is changed.

The counter 13 counts the number of times that output of the ExOR 15 becomes “1”. A mute signal is inputted from outside the audio data processing apparatus 10 to the counter 13. The mute signal is a signal for instructing operations of the audio data processing apparatus 10. In this embodiment, the mute signal represents a mute instruction (fade-out instruction) in “H” level, and represents a mute release instruction (fade-in instruction) in “L” level.

The counter 13 functions as a count-up counter when the mute signal is “H” level and functions as a countdown counter when the mute signal is “L” level. The counter 13 shall be able to count a value in the range of the number of bits in one word of audio data (e.g., when audio data is structured as 16 bits/word, the counter 13 shall be able to count in the range from 0 to 15). When the counter 13 functions as a count-up counter, all count values on and after “15” shall be “15”. When the counter 13 functions as a countdown counter, all count values on and after “0” shall be “0”.

When a count value by the counter 13 is “k”, the shift register 12 shifts inputted audio data for every word in the low bit direction by “k” bits and outputs the audio data. Thereby the outputted audio data becomes a value resulting from multiplying the inputted audio data by 2^{-k}. That is, every time a count value by the counter 13 is changed (every time the result of the foregoing volume comparison performed by the EXOR 15 is changed), the shift register 12 changes a shift amount of audio data.

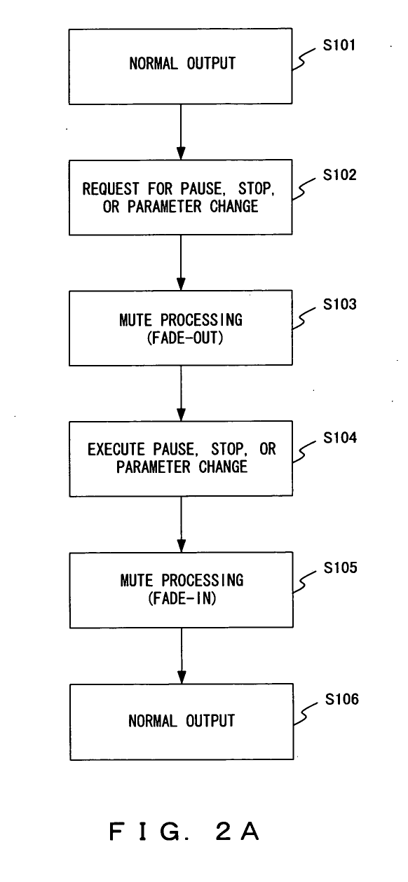

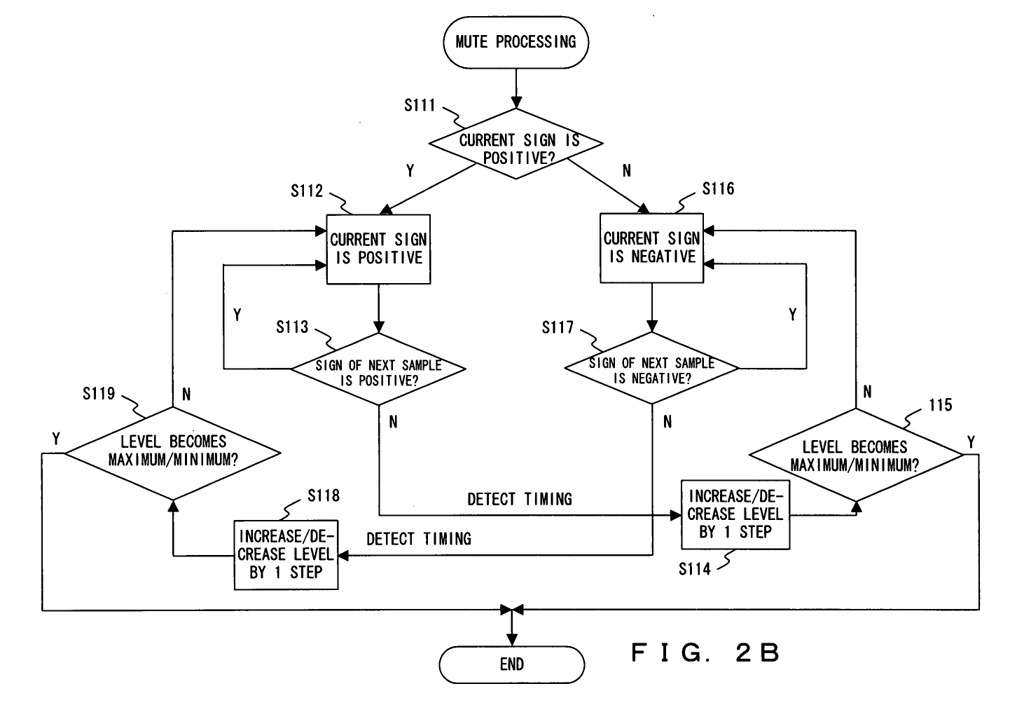

The audio data processing apparatus 10 shown in FIG. 1 is structured as above. Therefore, when a mute direction or a mute release direction is issued, the sound level expressed by audio data is changed at the sign change point of the audio data. Such an operation by the audio data processing apparatus 10 will be further explained accordingly to the flowcharts shown in FIG. 2A and FIG. 2B.

FIG. 2A shows processing by a control apparatus for controlling operations of the audio data processing apparatus 10.

First, in step S101 of FIG. 2A, the audio data processing apparatus 10 is made to perform output in a normal state. That is, the audio data processing apparatus 10 is made to output audio data inputted to the audio data processing apparatus 10 without shifting the audio data in the shift register 12.

In step S102, a request for changing the contents of audio processing, such as pause, stop, and parameter changes, which are made to an external audio processing apparatus sending audio data to the audio data processing apparatus 10 is acquired. When the request is acquired, in step S103, a mute signal is given to the audio data processing apparatus 10 to perform mute processing of fade-out. Then, the audio data processing apparatus 10 begins the mute processing.

After that (step S103), when the audio data processing apparatus 10 completes the mute processing, in step S104 the audio processing apparatus is made to perform changes according to the foregoing request. When the changes are completed, in step S105 a mute signal is given to the audio data processing apparatus 10 to perform mute processing of fade-in. Then, the audio data processing apparatus 10 begins the mute processing.

Next, when the audio data processing apparatus 10 completes the mute processing, in step S106 the audio data processing apparatus 10 is made to perform output in the normal state.

The following descriptions will be given of FIG. 2B. FIG. 2B illustrates the processing contents of the mute processing performed in the audio data processing apparatus 10. The processing begins according to execution of processing steps 103 and 105 of FIG. 2A.

First, in step S111, a judgment is made whether or not the sign of a current sample of audio data is positive. Here, when judged that the sign of the current sample is positive (when judged “Yes”), the flow is progressed from step S112 to step S113.

In step S113, judgment is made of whether or not a sign of the next sample of audio data is positive. The judgment processing is repeated until the sign of the next sample becomes negative (i.e., until judged “No”). When the sign of the next sample becomes negative (i.e., when judged “No”), the sign of the audio data has thus been inversed. The flowchart then progresses to step S114 and the sound level expressed by the audio data is either increased or decreased by 1 step, depending on the judgment. For example, when the ExOR 15 detects that the sign of the audio data is inverted, the counter 13 updates the count value by 1 (i.e., by increasing the count value by 1 in processing of fade-out and by decreasing the count value by 1 in the processing of fade-in) and the shift register 12 shifts the audio data in the low bit direction by the number of digits corresponding to the updated count value.

After processing in step S114, a judgment is made as to whether the sound level expressed by the audio data that has been changed in step S114 becomes the maximum (in fade-in) or becomes the minimum (in fade-out) in step S115. When judged “Yes”, the mute processing is completed.

When judged that the sign of the current sample is negative in step S111 (i.e., when judged “No”) or when judged “No” in step S115, the flow progresses from step S116 to step S117.

In step S117, judgment is made as to whether or not the sign of the next sample of the audio data is negative. The judgment processing is repeated until the sign of the next sample becomes positive (until judged “No”). Here, when the sign of the next sample is positive (when judged “No”), the sign of the audio data has been inversed. Then, the flow progresses to step S118 and the sound level expressed by the audio data is increased or decreased by one step. This may also be expressed as follows: when the ExOR 15 detects that the sign of the audio data is inverted, the counter 13 updates a count value by 1 (i.e., the counter 13 increases the count value by 1 in processing in fade-out, and decreases the count value by 1 in processing in fade-in), and the shift register 12 shifts the audio data in the low bit direction by the number of digits corresponding to the updated count value. The shift amount of audio data in the shift register 12 is changed every time a comparison result detected by the ExOR 15 is changed.

In step S119, judgment is made as to whether the sound level expressed by the audio data that has been changed in step S118 becomes the maximum (in fade-in) or becomes the minimum (in fade-out). When judged “Yes”, the mute processing is completed. Meanwhile, when judged “No”, the flow progresses from step S112 to step S113.

By performing the above mute processing in the audio data processing apparatus 10, the sound level expressed by the audio data changes at the sign change point of the audio data according to a mute instruction or a mute release instruction.

Next, the effects of performing the above mute processing in the audio data processing apparatus 10 will be described.

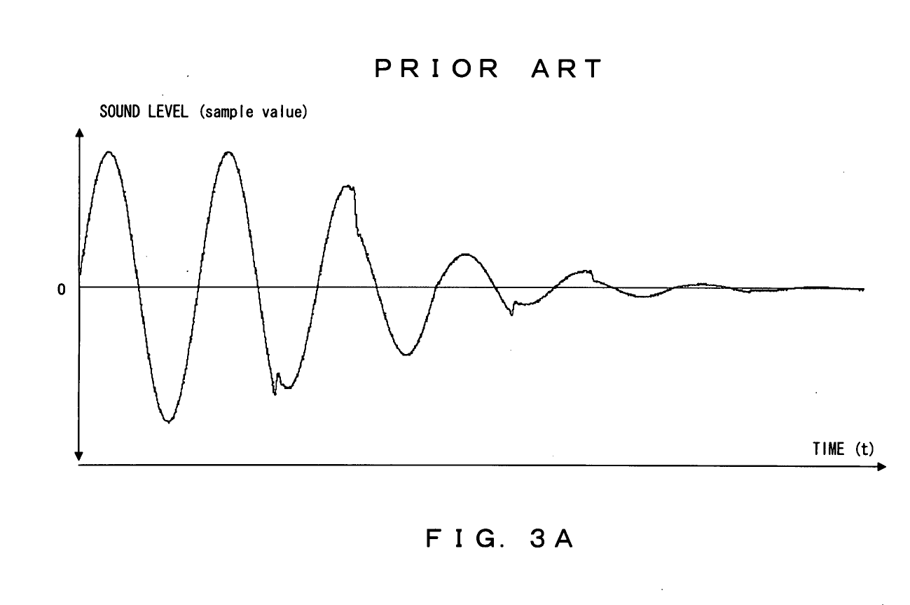

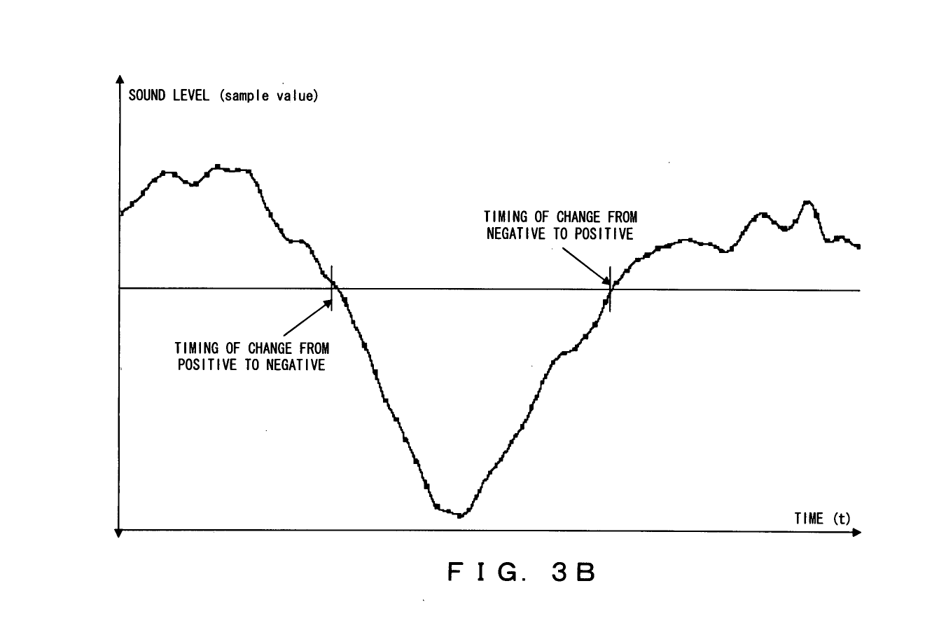

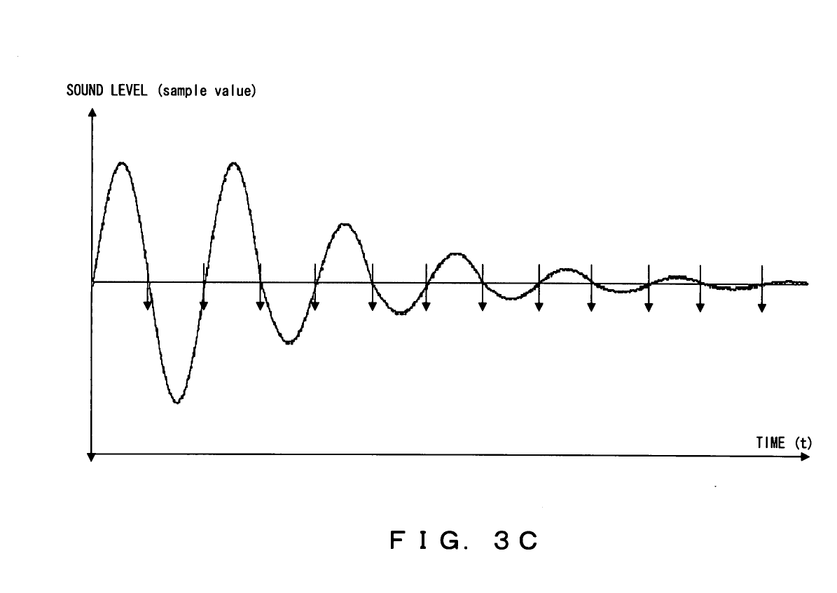

FIGS. 3A, 3B, and 3C respectively show time-series change in sound levels expressed by audio data.

FIG. 3A illustrates a change in the sound level when mute processing of fade-out is performed by using data shift by the shift register. In the case of FIG. 3A, however, the foregoing consideration of this embodiment is not given to timings of change in shift amounts in the shift register.

In the graph of FIG. 3A, notable irregularity is shown in a plurality of places. Such irregularity means that noise sound has occurred.

FIG. 3B shows the timings when the shift register 12, which shifts audio data in the audio data processing apparatus 10, changes shift amounts as described above. As shown in FIG. 3B, the shift register 12 changes shift amounts at the timing when the sign of the audio data is changed from positive to negative and at the timing when the sign is changed from negative to positive.

FIG. 3C shows change in the sound level when mute processing of fade-out is performed in the audio data processing apparatus 10 as described above. Arrows shown in FIG. 3C indicate timings when the shift register 12 changes shift amounts.

In the graph of FIG. 3C, irregularity as shown in FIG. 3A is not shown. The reason thereof is as follows: the shift amounts are changed when the sound level is a minute level close to zero level. Since the audio data processing apparatus 10 operates in this manner, noise sound is prevented from occurring even when the level is greatly changed by shift in the shift register 12.

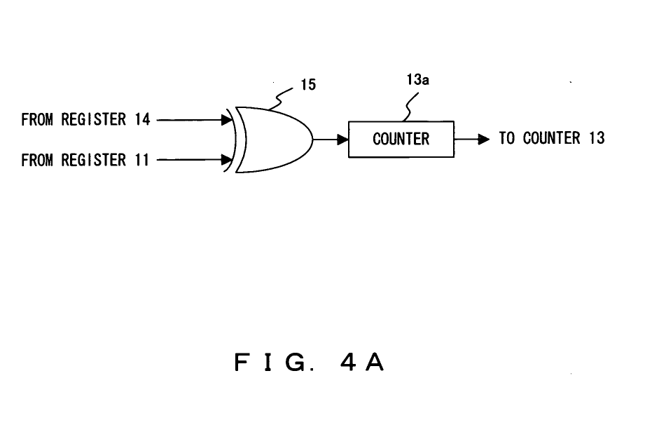

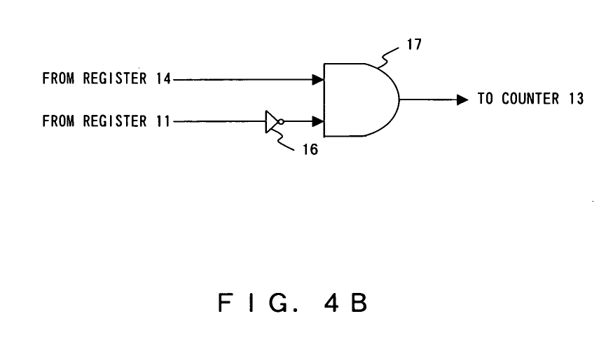

It is possible that, as shown in FIG. 4A, a counter 13a is provided between the output of the EXOR 15 and the counter 13 in the structure of the audio data processing apparatus 10, shown in FIG. 1. The counter 13a counts the number of times that output of the EXOR 15 becomes “1” and outputs “1” to the counter 13 every time the count value becomes a given number. Then, the counter 13 counts the number of times that output of the counter 13a becomes “1”.

By the foregoing structure, the shift register 12 changes the shift amount of audio data every time a count value by the counter 13 is changed, that is, every time the number of times of detecting a sign change point of audio data performed by the EXOR 15 reaches the foregoing given number. Thereby, the ratio of change in a sound level by mute processing can be moderated.

Furthermore, it is possible that the EXOR 15 in the structure of FIG. 1 is substituted with a circuit composed of a NOT circuit 16 and an AND circuit 17 shown in FIG. 4B. When the audio data processing apparatus 10 is structured in this manner, out of change of signs of audio data, detection is done only when a sign changes from negative to positive. Only in this case, the shift amount of audio data by the shift register 12 changes and the sound level changes. Thus, noise sound is prevented from occurring in this case as well.

In addition, it is also possible that within the circuit of FIG. 4B, the NOT circuit 16 is deleted, the most significant bit of audio data stored in the register 11 is directly inputted to the AND circuit 17, and the most significant bit of audio data stored in the register 14 is inputted via a NOT circuit to the AND circuit 17. When the audio data processing apparatus 10 is structured as described above, out of change of signs of audio data, detection is done only when a sign changes from positive to negative. Only in this case, the shift amount of audio data by the shift register 12 changes, and the sound level changes. Therefore noise sound is prevented from occurring in this case as well.

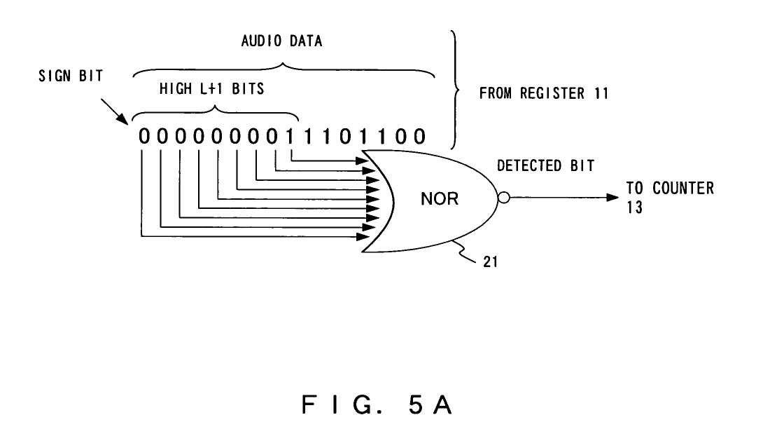

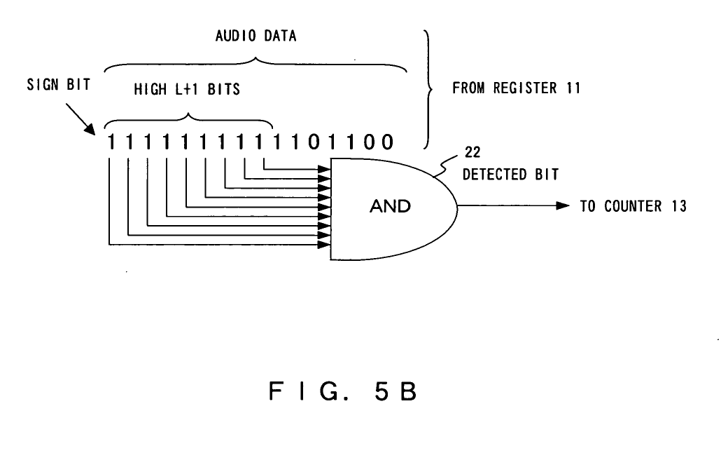

Additionally, the audio data processing apparatus 10 can be structured in such a manner that the EXOR 15 in the structure of FIG. 1 is substituted with a NOR circuit 21 shown in FIG. 5A or an AND circuit 22 shown in FIG. 5B.

The NOR circuit 21 of FIG. 5A outputs a value inverted from OR of each of given high L+1 bits including a sign bit out of audio data stored in the register 11. The NOR circuit 21 outputs “H” level to the counter 13 only when each of the given high L+1 bits stored in the register 11 is “0” (which is the same value as the value of the sign bit of the audio data). This is otherwise stated as only when the sign of the audio data is positive and the audio data represents a sound level smaller than a given value. Therefore, in this case, the shift register 12 shifts the shift amount of audio data every time the count value is changed by the counter 13 (i.e., every time the sign of the inputted audio data is positive and the inputted audio data represents a sound level equal to or less than a given threshold).

By the above-mentioned operation, the audio data processing apparatus 10 changes the sound level when the absolute value of the sound level is small, and therefore, the level of generated noise sound becomes small.

Further, the AND circuit 22 of FIG. 5B outputs AND of each of the given high L+1 bits, including a sign bit, from the audio data stored in the register 11. The AND circuit 22 outputs “H” level to the counter 13 only when the sign of audio data stored in the register 11 is negative and the absolute value of the sound level represents a value smaller than a given value. Therefore, in this case, the shift register 12 changes the shift amount of audio data every time the count value by the counter 13 changes, (i.e., every time the sign of inputted audio data is negative and the absolute value of a sound level becomes equal to or less than a given threshold).

By the above operation, the audio data processing apparatus 10 changes the sound level when an absolute value of the sound level is small. Thus, the level of generated noise sound becomes smaller.

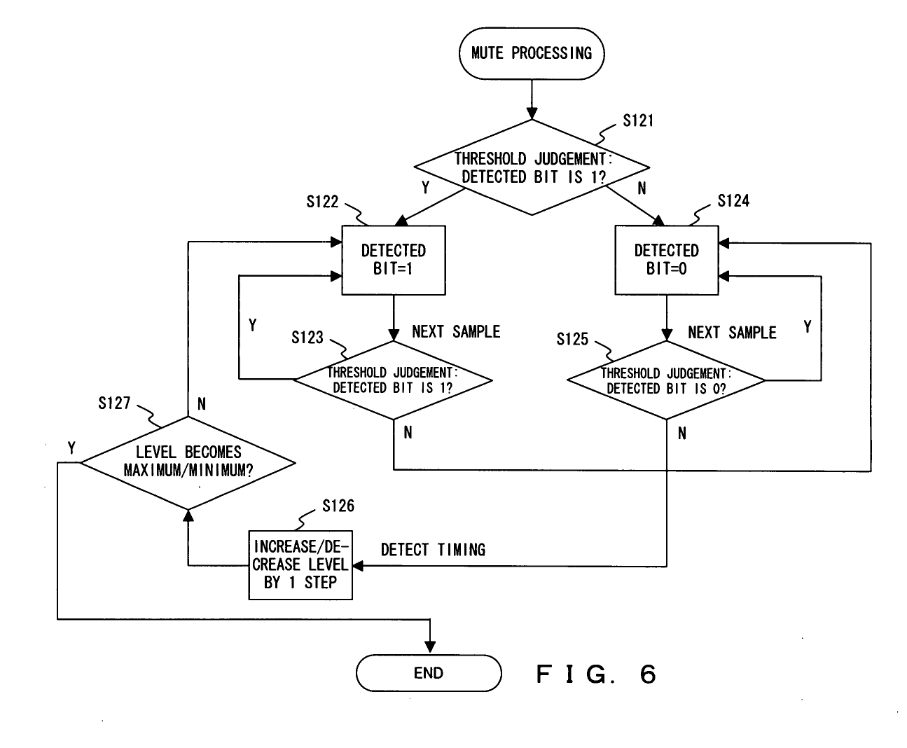

The previously mentioned operation by the audio data processing apparatus 10 will be further described according to the flowchart shown in FIG. 6. The control apparatus for controlling operations of the audio data processing apparatus 10 shall perform the processing shown in FIG. 2A.

FIG. 6 shows processing contents of mute processing performed in the audio data processing apparatus 10. The processing begins according to execution of the processing of steps S103 and S105 of FIG. 2A.

First, in step S121, judgment is made as to whether or not a detected bit for a current sample of audio data (the output of the NOR circuit or output of the AND circuit 22) is “1” (“H” level). Here, when judged that the detected bit for the current sample is “1” (when judged “Yes”), the flow progresses from step S122 to step S123. Meanwhile, when judged in step S121 that the detected bit of the current sample is “0” (“L” level) (when judged “No”), the flow progresses from step S124 to step S125.

In step S123, judgment is made whether or not a detected bit for the next sample of audio data is “1.” The judgment processing is repeated until the detected bit of the next sample becomes “0” (until judged “No”). Here, when the detected bit for the next sample becomes “0” (when judged No), a sound level expressed by the audio data has become larger than a given threshold. Thus, the flow progresses from step S124 to step S125.

In step S125, judgment is made whether or not the detected bit for the next sample of the audio data is “0.” The judgment processing is repeated until the detected bit for the next sample becomes “1” (until judged “No”). Here, when the detected bit of the next sample becomes “1” (i.e., when judged “No”), the absolute value of a sound level expressed by the audio data has become smaller than a given threshold. Thus the flow progresses to step S126.

In step S126, the sound level expressed by the audio data is increased or decreased by one step. That is, the counter 13 updates a count value by one (increases the count value by one in processing in fade-out, and decreases the count value by one in processing in fade-in) and the shift register 12 shifts the audio data in the low bit direction by the number of digits corresponding to the updated count value.

In step S127, judgment is made as to whether the sound level expressed by the audio data, changed in step S126, becomes the maximum (in fade-in) or becomes the minimum (in fade-out). When judged “Yes”, the mute processing is completed. However, when judged “No”, the flow is progressed from step S122 to step S123.

By performing the foregoing mute processing, when the absolute value of the sound level expressed by the audio data becomes a value equal to or less than the given threshold, the audio data processing apparatus 10 changes the sound level according to a mute instruction or a mute release instruction. In result, the level of generated noise sound becomes small.

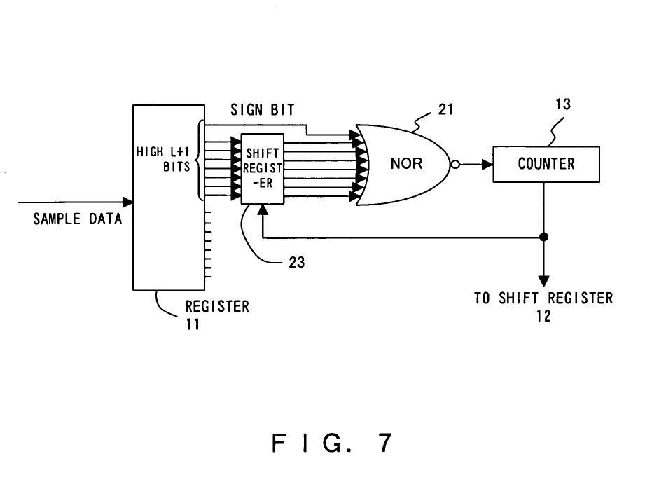

Further, when the audio data processing apparatus 10 is structured by using the NOR circuit 21 shown in FIG. 5A, a shift register 23 can be further added thereto as shown in FIG. 7.

Out of each of high L+1 bits of audio data inputted to the NOR circuit 21, bit data in L digits other than a sign bit in the most significant digit is inputted to the shift register 23. The bit data is shifted in the low bit direction by the number of digits corresponding to a count value by the counter 13. Data “0” is inserted in the high digit bits after shift.

In the audio data processing apparatus 10, further added with the shift register 23, every time a sign of inputted audio data is positive and the inputted audio data represents a sound level equal to or less than a given threshold, the threshold changes (i.e., becomes larger gradually in fade-out, and becomes smaller gradually in fade-in).

When the sound level is small in the middle of executing soft mute, generated noise sound can be maintained small even if the threshold is increased. When the threshold is increased, it can be expected that frequency of updating a count value of the counter 13 is increased. Therefore, by the above structure, time needed for mute processing can be shortened.

In FIG. 7, the shift register 23 is arranged on the input side of the NOR circuit 21 (shown in FIG. 5A). However, when the shift register 23 is arranged on the input side of the AND circuit 22 (shown in FIG. 5B), the audio data processing apparatus can perform similar operations. However, in the latter case, data “1” shall be inputted in the high digit bits after the shift.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents, patent applications and sequences identified by their accession numbers mentioned in this specification are herein incorporated in their entirety by reference into the specification, to the same extent as if each individual publication, patent or patent application or sequence identified by their accession number was specifically and individually indicated to be incorporated herein by reference. In addition, citation or identification of any reference in this application shall not be construed as an admission that such reference is available as prior art to the present invention.

What is claimed is:

1. An apparatus for processing audio data, comprising:
a comparing unit for performing volume comparison between a sound level expressed by audio data and a given threshold; and
a changing unit for changing the sound level expressed by the audio data when a result of the comparison by the comparing unit is changed.

2. The apparatus according to claim 1, wherein
the given threshold is zero level.

3. The apparatus according to claim 2, wherein
the audio data is expressed in the form of two's complement,
the comparing unit includes a detecting unit for detecting a sign change point of the audio data, and
the changing unit changes the sound level expressed by the audio data at the sign change point.

4. The apparatus according to claim 3, wherein
the detecting unit detects whether or not a sign of data at a given time of the audio data is inverted from a sign of data which is one sample before the data at the given time of the audio data.

5. The apparatus according to claim 4, further comprising:
a first register for storing the audio data; and
a second register for storing audio data which is one sample before the audio data stored in the first register, wherein
the detecting unit is an exclusive OR circuit which outputs exclusive OR between a sign bit of the audio data stored in the first register and a sign bit of the audio data stored in the second register.

6. The apparatus according to claim 1, wherein
the changing unit is a shift register for shifting the audio data.

7. The apparatus according to claim 6, wherein
the audio data is expressed in the form of two's complement,
the comparing unit includes a detecting unit for detecting a sign change point of the audio data, and
the shift register changes a shift amount of the audio data every time the detecting unit detects the sign change point.

8. The apparatus according to claim 6, wherein
the audio data is expressed in the form of 2's complement,
the comparing unit includes a detecting unit for detecting a sign change point of the audio data, and
the shift register changes a shift amount of the audio data every time the detecting unit detects the sign change point a given number of times.

9. The apparatus according to claim 1, wherein
the audio data is expressed in the form of two's complement, and
the comparing unit produces a result of the comparison based on whether or not all values of high bits in a given number of digits in the audio data correspond with a value of a sign bit of the audio data.

10. The apparatus according to claim 1, further comprising
a threshold changing unit for changing the given threshold when the result of the comparison by the comparing unit is changed.

11. A method for processing audio data, comprising:
performing volume comparison between a sound level expressed by audio data and a given threshold; and
changing the sound level expressed by the audio data when a result of the comparison is changed.

12. The method according to claim 11, wherein
the given threshold is zero level.

13. The method according to claim 12, wherein
the audio data is expressed in the form of two's complement,
the volume comparison is performed by detecting a sign change point of the audio data, and
when the sign change point is detected, the sound level expressed by the audio data is changed at the sign change point.

14. The method according to claim 13, wherein
in detecting the sign change point, detection is made as to whether or not a sign of data at a given time of the audio data is inverted from a sign of data which is one sample before the data at the given time of the audio data.

15. The method according to claim 14, wherein
the sign change point is detected by obtaining exclusive OR between a sign bit of the audio data at a given time and a sign bit of audio data which is one sample before the audio data.

16. The method according to claim 11, wherein
by using a shift register for shifting the audio data, a sound level expressed by the audio data is changed.

17. The method according to claim 16, wherein
the audio data is expressed in the form of two's complement,
the volume comparison is performed by detecting a sign change point of the audio data, and
every time the sign change point is detected, a shift amount of the audio data by the shift register is changed.

18. The method according to claim 16, wherein
the audio data is expressed in the form of two's complement,
the volume comparison is performed by detecting a sign change point of the audio data, and
every time the sign change point is detected a given number of times, a shift amount of the audio data by the shift register is changed.

19. The method according to claim 11, wherein
the audio data is expressed in the form of two's complement, and
a result of the volume comparison is obtained based on whether or not all the values of high bits in a given number of digits in the audio data correspond with the value of a sign bit of the audio data.

20. The method according to claim 11, wherein
the given threshold is changed when the result of the volume comparison is changed.
